(19) United States
(12) Patent Application Publication
(10) Pub. No.: US 2011/0093280 A1
(43) Pub. Date: Apr. 21, 2011

(54) Computer Implemented Modular Based Medical Market Analysis System

(76) Inventor: Jan Andre Heybroek, Alpharetta, GA (US)

(21) Appl. No.: 12/582,056

(22) Filed: Oct. 20, 2009

(51) Int. Cl. G06Q 50/00

(52) U.S. Cl. 705/2

(57) ABSTRACT

Disclosed is an online computerized disease intelligence platform for use in medical market analysis. The system provides a physician's view of the medical market and disease landscape using physician interaction and real-time data feeds. Furthermore, the system identifies and uses expert thought leader physicians in analyzing treatment protocols and trends in providing reports to users of the platform. The system further graphically maps physician influences and identified thought leaders in therapy areas.

### FIELD OF THE INVENTION

The present invention generally relates to a computer implemented modular based system for providing medical market analysis and more specifically the invention relates to an online computerized disease intelligence platform using physician interaction and real-time data feeds.

### BACKGROUND

The medical market is exceedingly complex having a myriad of many different diseases with numerous treatments for each. Treatment protocols change as new research and drugs become available to the medical market. Keeping up to date as to the latest protocols used by clinicians and indentifying the most effective treatment is difficult. Busy physicians, medical professionals, drug companies, and medical device manufactures are often unable to have a full understanding of the changing medical market.

Thus, what is needed is a method capable of providing those interested in the medical market a real-time analysis of the latest treatments being used presently by clinicians, their rationale and what impacts their decision-making.

### SUMMARY

The present invention generally relates to an online computerized disease intelligence platform for use in medical market analysis. The system provides a physician's view of the medical market and disease landscape using physician interaction and real-time data feeds. Furthermore, the system identifies and uses expert thought leader physicians in analyzing treatment protocols and trends. The system further graphically maps physician influences.

In greater detail, the present system includes a computer implemented modular based real-time medical market analysis method identifying at least one thought leader physician for a targeted therapy area and providing a patient treatment protocol reported by the physician. In an embodiment, the computer system includes providing a professional profile of the physicians and thought leader physicians including publications and clinical trials related to the physician. The publications and clinical trials information is updated in real time with available hyperlinks provided. Furthermore, there is also provided a graphical representation of the thought leader's influence related to other physicians.

Regarding the graphical mapping of the physician's influence, the thought leader's influence to one or more additional thought leaders is shown. In this embodiment additional thought leaders select a thought leader physician and the additional thought leaders can be selected by the thought leader physician. Furthermore, the mapped influence can be graphically represented having a target physician, wherein the target physician's relationship is mapped to the thought leader physician. Additionally, the physician's influence can be graphically represented geographically.

In a further embodiment, there is provided a computer implemented modular based real-time medical market analysis system comprising a physician and thought leader module. This module includes displaying physician and thought leader profiles and displaying a treatment protocol report. Also provided is a clinical intelligence module including displaying a treatment log report and an analysis module including displaying insight reports providing analysis of treatment decisions by thought leader physicians.

In the modular embodiment, the physician and thought leader module further includes graphically representing an influence of a thought leader physician related to other physicians. The displayed treatment protocol report of this module is comprised of an aggregation of treatment profiles. The treatment profiles are electronically collected from electronically distributed physician surveys.

The clinical intelligence module includes the displayed treatment log report comprised of an aggregate collection of clinician treatment logs of physician treatment decisions. The clinician treatment log is an electronic form wherein the clinical treatment decisions, the underlying rationale and decision influences are entered. The entries are displayed in real-time in the treatment log report. The treatment log report can be a combination of treatment logs aggregated and analyzed for an interval of time such as monthly and further viewable in a twelve month trailing view.

Additionally, the displayed insight reports are further selected from the group consisting essentially of market trend reports, customized market reports based upon physician surveys. Also, access provided to a user or subscriber can be limited to certain modules depending upon a subscription plan or other criteria.

A further embodiment includes providing supplemental information modules selected from groups such as trial site profiling, institution clinical trial analysis and field activity tracking systems. The trial site profiling module includes displaying general site information and hyperlinks to affiliated investigator profiles. The field activity tracking systems module includes field uploaded data supplements providing prefilled intelligence forms with validated customer relationship management resources. A further aspect of the system is that it combines qualitative and quantitative research and analysis in one system.

### DRAWINGS

In the Drawings:

FIG. 1 is a graphical representation of the influence of a thought leader related to other physicians showing geographical influence and referral influence and further showing the target physician including hyperlinking profiles of represented physicians in the graphic influence map;

FIG. 2 is a screenshot of the computer based method showing the thought leader's profile including therapy areas and further depicting the though leader's publications and associate clinical trials with available hyperlinks for each;

FIG. 3 depicts a thought leader physician's ranking relative to other thought leaders in the physician's related therapy area;

FIG. 4 is a screenshot depicting the clinician treatment log showing individual patient treatments wherein the patient's demographics, the diagnosis including the disease, disease stage and type of diagnosis, further shown is the treatment description, rationale, and decision considerations;

FIG. 5 is a screenshot illustrating a physician's treatment profile derived from physician surveys and profile depicting the diseases seen by the physician, the percentage of patients seen with the disease and the type of treatments used and how often such treatments were used;

FIG. 6 is a screenshot of a yearly trend report of the treatment log report showing the treatment trends for a disease graphically presented and an insight report providing analysis of the treatment decisions;

FIG. 7 is a screenshot of a treatment log report; and

FIG. 8 is a screenshot of a treatment protocol report.

### DETAILED DESCRIPTION

Disclosed is an online computerized disease intelligence platform for use in medical market analysis. The system provides a physician's view of the medical market and disease landscape using physician interaction and real-time data feeds. Furthermore, the system identifies and uses expert thought leader physicians in analyzing treatment protocols and trends. The system further graphically maps physician influences.

The computerized system includes a computer implemented modular based real-time medical market analysis method identifying at least one thought leader physician for a targeted therapy area and providing a patient treatment protocol reported by the thought leader. The system is implemented via the internet and includes the required servers, storage devices and connections known for implementing internet connections and communications. Furthermore the system includes an algorithm for performing the method and system.

However, the systems and methods described herein are not limited to any particular hardware or software configuration, but rather they may be implemented in any computing or processing environment, including in digital electronic circuitry or in computer hardware, firmware or software. The various processing modules may be implemented, in part, in a computer program product tangibly embodied in a machine-readable storage device for execution by a computer processor. In some embodiments, these modules preferably are implemented in a high level procedural or object oriented programming language; however, the algorithms may be implemented in assembly or machine language, if desired.

Additionally, the programming language may be a compiled or interpreted language. The methods described herein may be performed by a computer processor executing instructions organized, e.g., into program modules to carry out these methods by operating on input data and generating output. Suitable processors include, e.g., both general and special purpose microprocessors. Generally, a processor receives instructions and data from a read-only memory and/or a random access memory.

Storage devices suitable for tangibly embodying computer program instructions include all forms of non-volatile memory, including, e.g., semiconductor memory devices, such as EPROM, EEPROM, and flash memory devices; magnetic disks such as internal hard disks and removable disks; magneto-optical disks; and CD-ROM. Any of the foregoing technologies may be supplemented by or incorporated in specially-designed ASICs (application-specific integrated circuits).

Additionally, described within the system are modules, which can be used to breakdown the present system into managed portions for distribution to users having limited access to one or more of the modules. Additionally, the modules may be used to aid in the understanding of the system. However, the functions listed for each module are not intended to be exclusive or exhaustive and may be interchanged or duplicated in various embodiments and modules of the system. Furthermore, the titles given the modules are for reference only and are not intended to be limiting in anyway. Also the term “module” may refer to the system providing disease specific modules.

Essentially, three modules can be referenced within the disease-specific intelligence system. One module includes the mapping of physician influence and providing profiles of clinicians, thought leaders and institutions. The module provides a database of clinicians, thought leaders and institutions accessible to users for use in mapping influences and accessing patient management analysis.

A second module may be directed to a clinical intelligence database including standing clinician panels and clinician treatment logs. Clinical treatment may be directly reported by clinicians to the system providing specific treatment intelligence. Within this module there is an ongoing interactive communication with clinicians and includes the establishment of a standing clinician panel for reviewing data. Additionally the system combines the rationale and treatment decision influences with the actual treatment decision on an individual patient.

A third module includes the thought leaders providing analysis and insight. Thought leader analysis may take the form of bi-monthly market trends and bi-monthly treatment decisions analysis. Additionally, the thought leaders may prepare customized market reports which may included customized clinician surveys and poll questions offering direct feedback for analysis and insight. The thought leader may in an alternative embodiment edit such market reports prepared by third parties provided comment and analysis.

Furthermore, supplemental information modules may be included in the system. By way of example and not limitation, such modules may include; trial site profiling, institution clinical trial analysis and field activity tracking systems. The trail site profiling module may include general center contact information and hyperlinks to affiliated investigator profiles. The field activity tracking system module may inlcude prefilled profiling forms which can eliminate the need for field teams to start from scratch. Also included may be real-time updating and continuous information gathering with filed updated data supplements with prefilled intelligence.

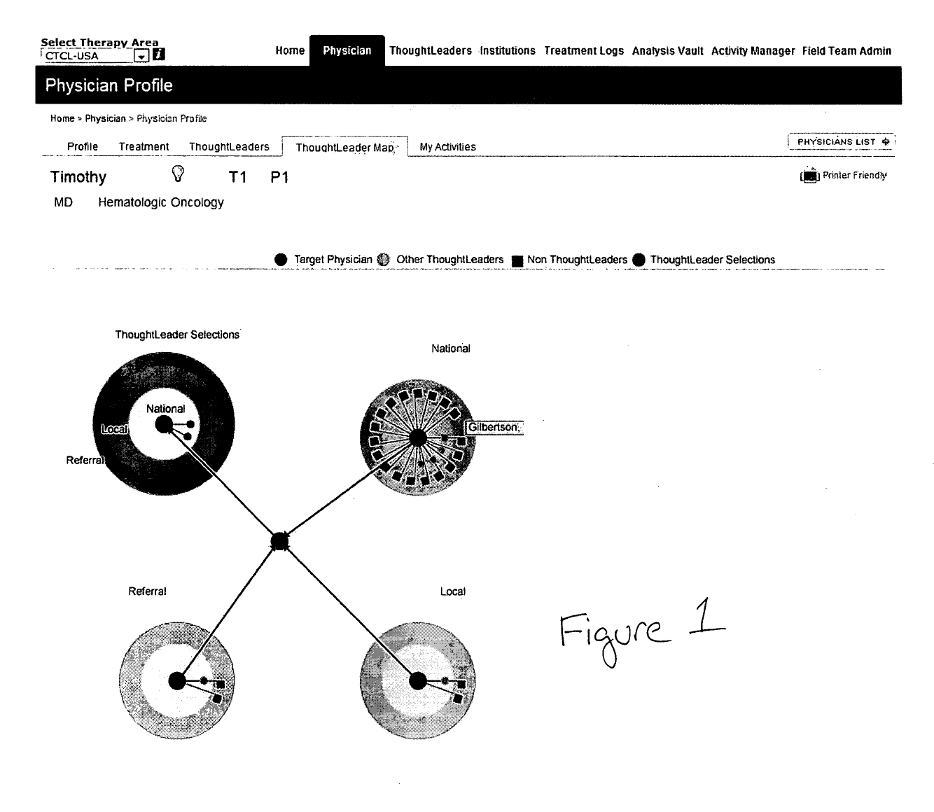

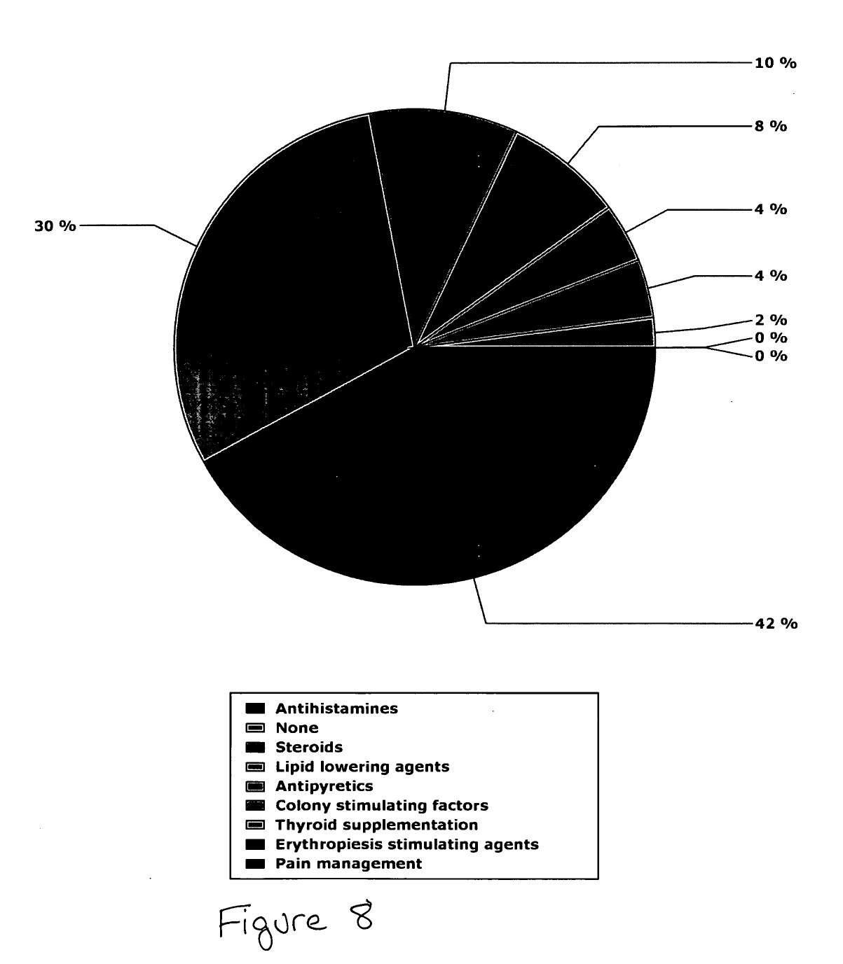

Referring now in greater detail to the drawings in which like numerals indicate like items throughout the several views, FIGS. 1-8 depict the online computerized disease intelligence platform for use in medical market analysis.

Shown in FIG. 1 is an embodiment of a graphical representation of the thought leader's influence related to other physicians showing geographical influence and referral influence. The term “influence” in an embodiment can include how the thought leader is perceived as a leader in a therapy area and how other physicians designate that thought leader as a person whom they respect and follow. While there is shown a particular graphic display of the influence of the thought leader other representations are contemplated which can convey the same meaning. Additionally, a non-thought leader may be shown as the physician being mapped in the influence network. As shown, the target physician is also a thought leader.

Turning now to the specific embodiment shown in FIG. 1, the red dot in the center identifies the target physician for whom the influence network is mapped. Of course in this case, the thought leader is also the target physician. The green dots are physicians the target physician has picked. The orange dots are other thought leaders who have picked the target physician with themselves having been picked as thought leaders. The blue squares are those physicians who have picked the target physician as a thought leader but haven't been picked themselves. All of these dots and squares represent individual physicians and the symbols are hyperlinked to their profiles. The dots and squares will give a “mouse-over” effect showing the individual's name when moving the cursor over the symbol. Further shown, is the influence network based upon a geographical influence on both a local or national basis. Additionally, the influence network can be mapped in relation to referrals.

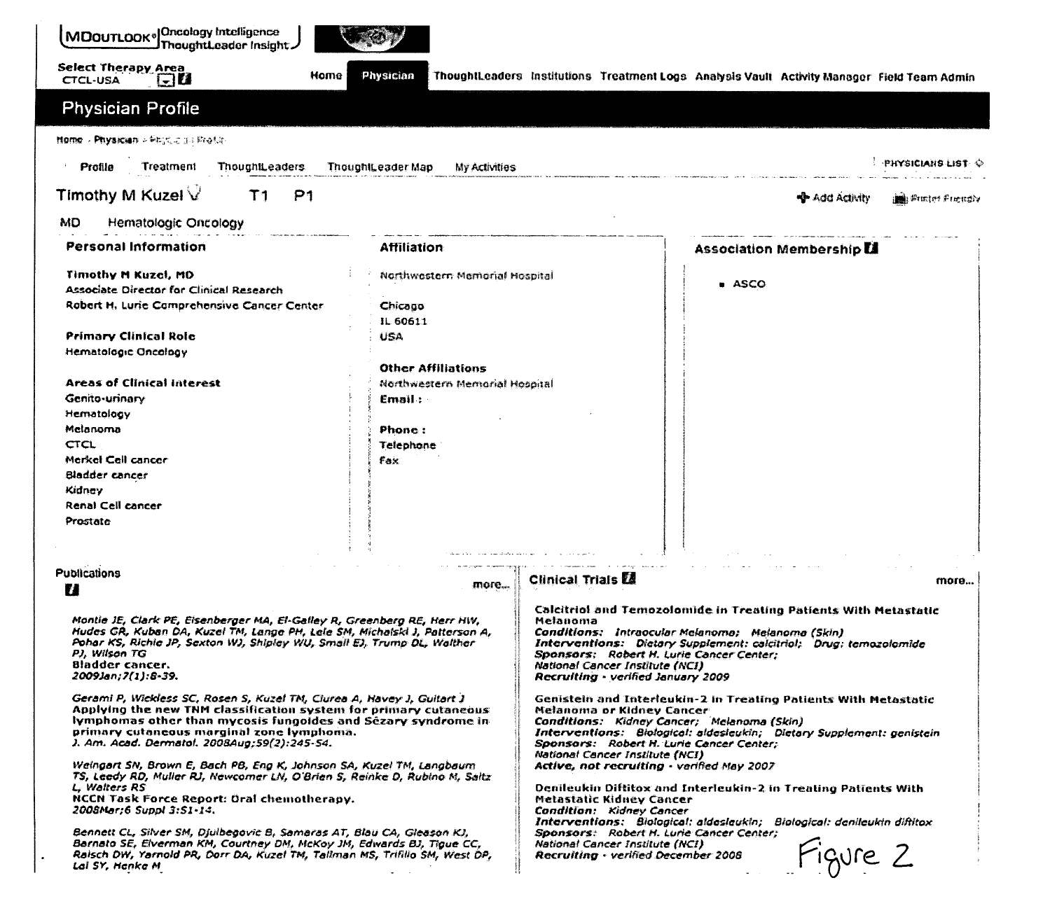

FIG. 2 is a screenshot of the computer based method showing the thought leader's profile including therapy areas and further depicting the though leader's publications and associated clinical trials with available hyperlinks for each.

The physician profile is not just limited to thought leaders. Other physicians in the database may be listed with profiles that are not thought leaders. Typically, these physicians can be referred to in an embodiment as followers of a thought leader in the database. Furthermore, institutions may also be profiled. The profile is not just limited to the embodiment shown in FIG. 2 and other information may also be contained in the profile which may be considered pertinent to a user of the method.

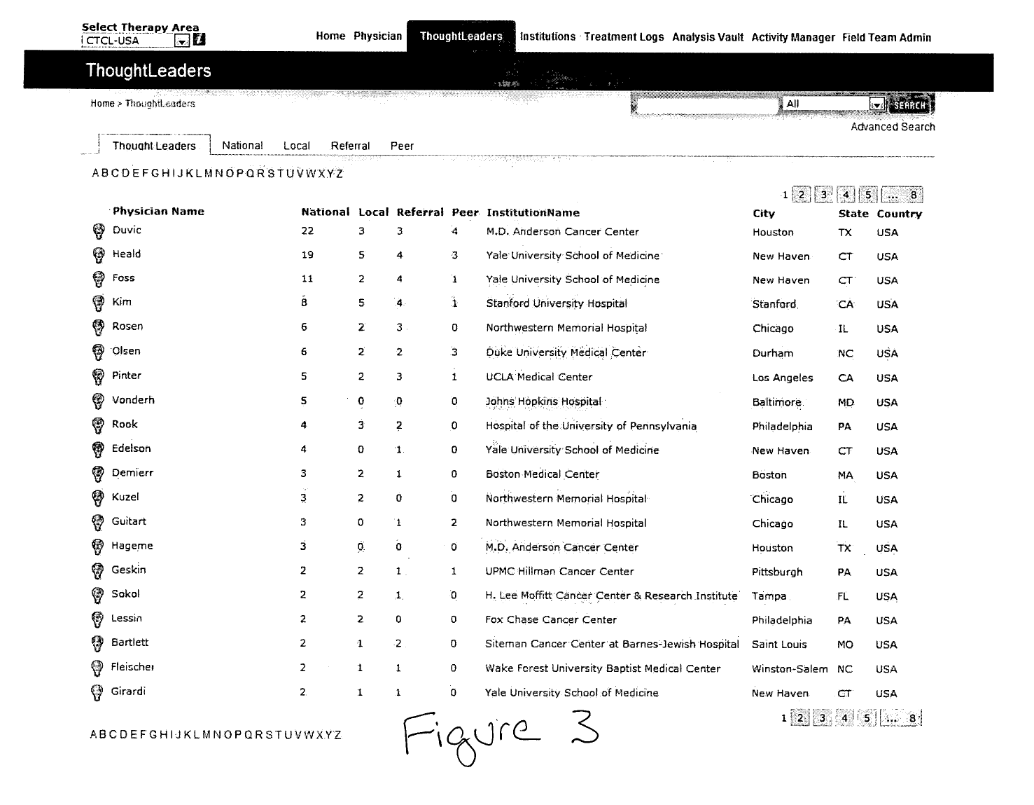

FIG. 3 depicts a thought leader physician's ranking relative to other thought leaders in the physician's therapy area. The ranking of thought leaders may in an embodiment be specific to a therapy area, and that therapy area only. Essentially, a person is ranked as a thought leader by the number of votes or selections the person has received in a targeted survey. The surveys ask the respondents for ranking per specific role and classification (national, local, referral), and a person may then be shown as a thought leader when selected.

Respondents cannot select themselves but can select anyone in the system database, even if the selected person has no activity or focus on the therapy area. Also, a respondent can add a thought leader de novo if they cannot find the person in the system.

Thought leader selection may in an embodiment be region specific (North America, EU, and the remaining regions). However, it is contemplated the selection may expand beyond such regions.

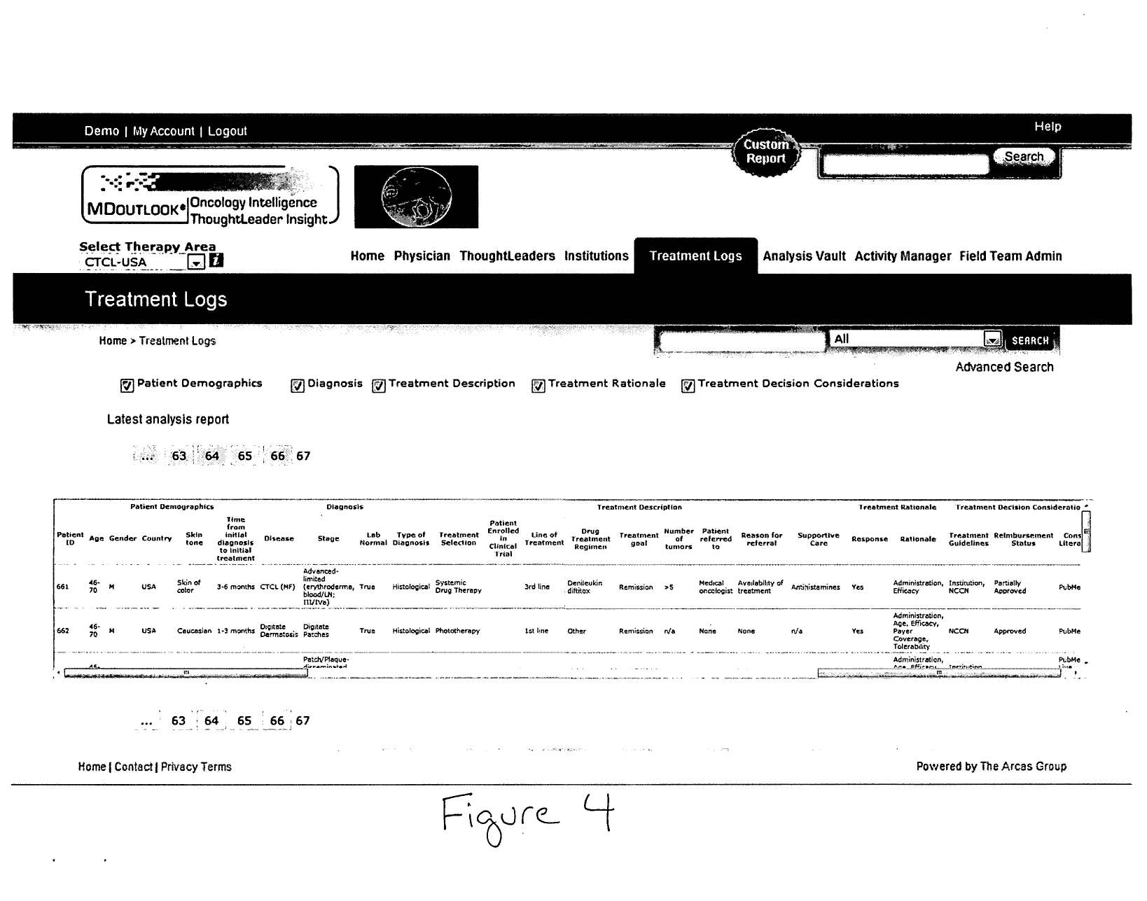

FIG. 4 depicts the clinician treatment log showing individual patient treatments wherein the patient's demographics, the diagnosis including the disease, disease stage and type of diagnosis. Further shown in the screenshot of the clinician treatment log are the treatment description, rationale, and decision considerations. The clinician treatment log comprises in part an embodiment including an electronic entry form that a physician may use to submit treatment decisions into the system via the internet or electronic medium. The user or subscriber to the present system may view individual treatment log records.

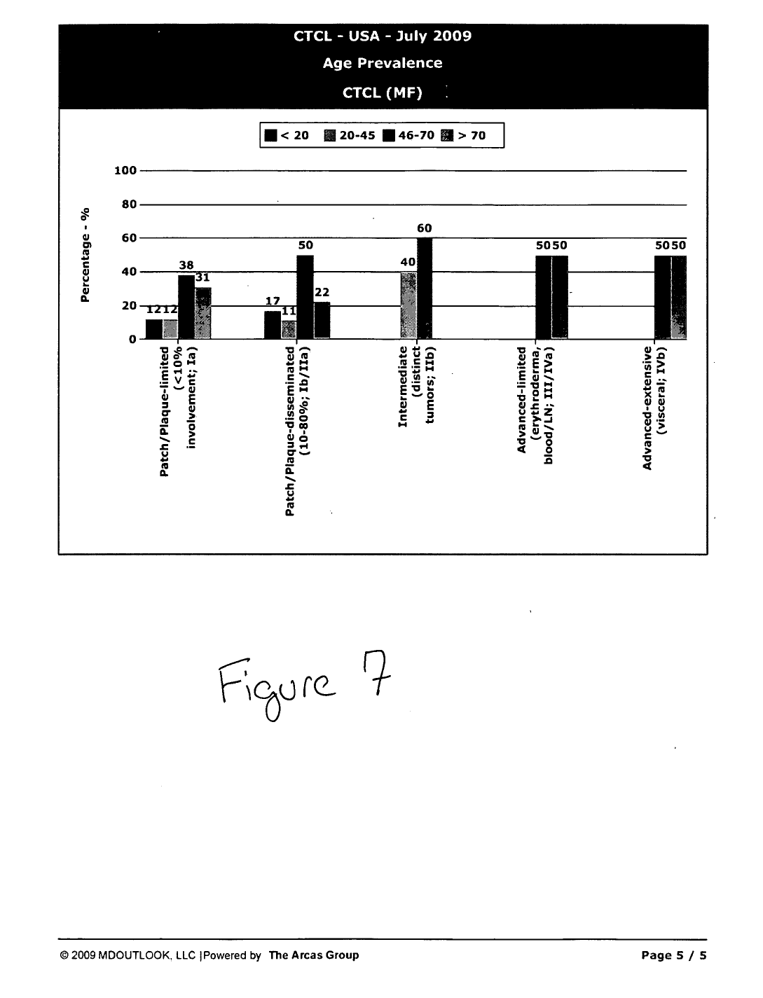

The screenshot shown in FIG. 7 is a treatment log report which is the aggregation of the combined treatment logs. Also, the treatment log report may be a tabulated and analyzed aggregation of the treatment logs displayed as monthly treatment log reports. Additionally, a twelve month trailing view of the reports may be provided.

A shown in FIG. 4, the generated graphical interface of the method presents various tabs having labels such as “Physician”, “Institutions” and “Treatment Logs” in an embodiment. Currently shown is the “Treatment Logs” tab generating the shown clinician treatment log. However, the clinician treatment log is not limited to any one tab and may fall under other tabs not listed and to more than one tab.

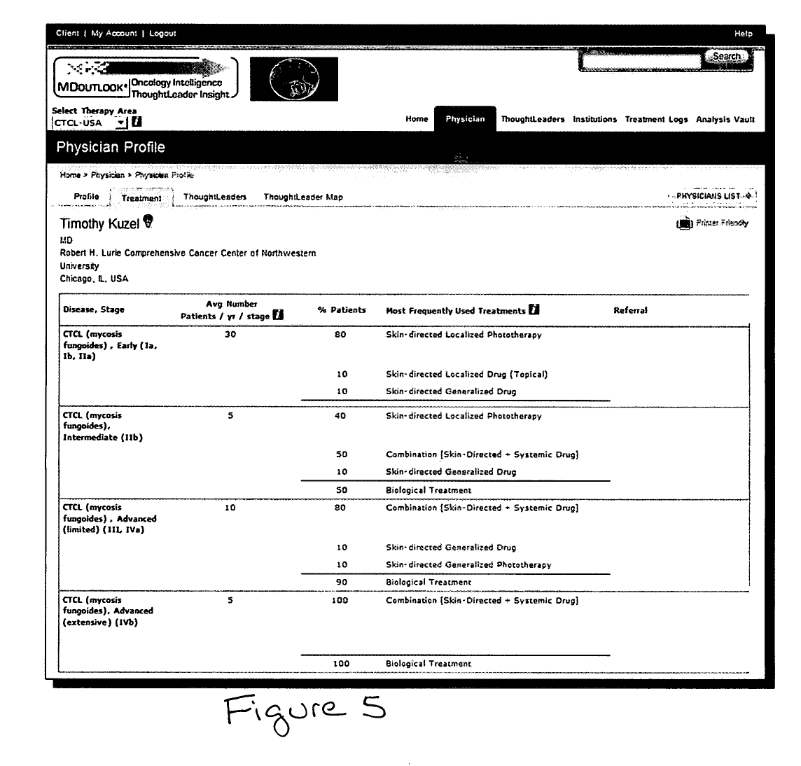

FIG. 5 is a screenshot illustrating a physician's treatment profile derived from physician surveys and profiles depicting the diseases seen by the physician, the percentage of patients seen with the disease and the type of treatments used and how often such treatments were used.

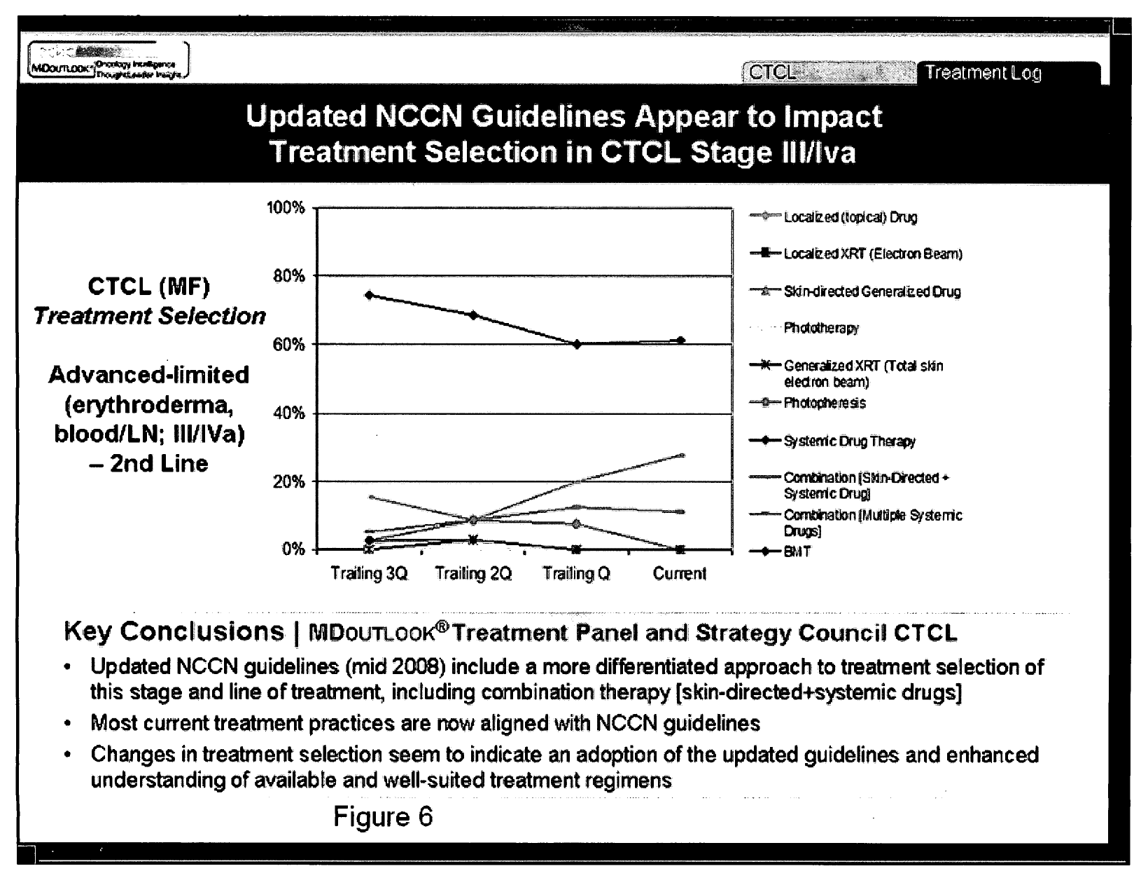

FIG. 6 is a screenshot of a yearly trend report of the treatment log report showing the treatment trends for a disease graphically presented and insight report providing analysis of the treatment decision.

While Applicants have set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

1. A computer implemented modular based medical market analysis system comprising:
identifying at least one thought leader physician for a targeted therapy area;
providing a patient treatment protocol reported by the thought leader;
graphically representing an influence of the thought leader related to other physicians.

2. The medical market analysis system of claim 1, further including providing a professional profile of the thought leader physician including publications and clinical trials related to the thought leader physician in real time.

3. The medical market analysis system of claim 2, further including updating in real-time the provided publications and clinical trials wherein available hyper links to each clinical trial and publication are provided.

4. The medical market analysis system of claim 1, wherein the graphically represented thought leader's influence includes graphically representing the thought leader's influence to one or more additional thought leaders, wherein the additional thought leaders select the thought leader physician.

5. The medical market analysis system of claim 1, wherein the graphically represented thought leader's influence includes graphically representing the thought leader's influence to one or more additional thought leaders, wherein the additional thought leaders are selected by the thought leader physician.

6. The medical market analysis system of claim 1, wherein the influence of the thought leader physician is graphically represented on a national geographical area a local geographic area and a patient referral basis.

7. The medical market analysis system of claim 5, wherein the local geographic area is selected from the group consisting of cities, counties, states and combinations thereof.

8. The medical market analysis system of claim 1, wherein the graphically represented thought leader's influence includes graphically representing the thought leader's influence to one or more physicians not chosen as thought leaders, wherein the physicians not chosen as thought leaders select the thought leader physician.

9. The medical market analysis system of claim 1, wherein the graphically represented thought leader's influence includes graphically representing a target physician and the target physician's relationship to the thought leader physician.

10. The medical market analysis system of claim 1, wherein the influence of the thought leader physician is graphically represented on a referral network of physicians.

11. The medical market analysis system of claim 1, wherein the graphically represented thought leader's influence includes providing a hyperlinked profile of a graphically represented physician.

12. The medical market analysis system of claim 1, wherein indentifying the thought leader physician includes physicians selecting the thought leader physician.

13. The medical market analysis system of claim 1, further including ranking the thought leader physicians relative to each other.

14. A computer implemented modular based real-time medical market analysis system comprising:
providing a physician and thought leader module including displaying physician and thought leader profiles and displaying a treatment protocol report;
providing a clinical intelligence module including displaying a treatment log report; and
providing an analysis module including displaying insight reports providing analysis of treatment decisions by thought leader physicians.

15. The medical market analysis system of claim 14, wherein the physician and thought leader module further including graphically representing an influence of a thought leader physician related to other physicians.

16. The medical market analysis system of claim 15, wherein the graphically represented thought leader's influence includes graphically representing the thought leader's influence to one or more physicians not chosen as thought leaders, wherein the physicians not chosen as thought leaders select the thought leader physician.

17. The medical market analysis system of claim 16, wherein the graphically represented thought leader's influence includes graphically representing the thought leader's influence to one or more additional thought leaders, wherein the additional thought leaders select the thought leader physician and graphically representing the thought leader's influence wherein the additional thought leaders are selected by the thought leader physician.

18. The medical market analysis system of claim 15, wherein the influence of the thought leader physician is graphically represented on a national geographical area and a local geographic area basis.

19. The medical market analysis system of claim 14, wherein the displayed treatment protocol report is comprised of an aggregation of treatment profiles.

20. The medical market analysis system of claim 19, wherein the treatment profiles are electronically collected from electronic physician surveys.

21. The medical market analysis system of claim 14, wherein the displayed treatment log report comprises an aggregate of collected clinician treatment logs comprised of physician treatment decisions.

22. The medical market analysis system of claim 21, wherein the clinician treatment log includes an electronic form wherein the clinical treatment decisions are entered.

23. The medical market analysis system of claim 21, wherein the treatment log report is a combination of treatment logs aggregated and analyzed for an interval of time.

24. The medical market analysis system of claim 23, wherein the interval of time is a month and the treatment log report is displayed as a monthly report with a trailing monthly view.

25. The medical market analysis system of claim 14, wherein the displayed insight reports are further selected from the group consisting essentially of market trend reports, customized market reports based upon physician survey and combinations thereof.

26. The medical market analysis system of claim 14, further including providing a user access limited to at least two of the three modules.

27. The medical market analysis system of claim 14, further including providing supplemental information modules selected from the group consisting essentially of trial site profiling, institution clinical trial analysis, field activity tracking systems and combinations thereof.

28. The medical analysis system of claim 27, wherein the trial site profiling module includes displaying general site information and hyperlinks to affiliated investigator profiles.

29. The medical analysis system of claim 27, wherein the field activity tracking systems module includes field uploaded data supplements providing prefilled intelligence wherein validated customer relationship management resources.

30. A computer implemented modular based real-time medical market analysis system comprising:
providing a physician and thought leader module including displaying physician and thought lead profiles and displaying a treatment protocol report wherein the displayed treatment protocol report is comprised of an aggregation of treatment profiles and graphically representing an influence of a thought leader physician related to other physicians;
providing a clinical intelligence module including displaying a treatment log report, wherein the treatment log report comprises an aggregate of collected clinician treatment logs comprised of physician treatment decisions, wherein the clinician treatment log is an electronic form wherein the clinical treatment decisions are entered; and
providing an analysis module including displaying insight reports providing analysis of treatment decisions by thought leader physicians.

31. The medical market analysis system of claim 30, wherein the clinician treatment log is an electronic form wherein the clinical treatment decisions are entered.

32. The medical market analysis system of claim 30, wherein the treatment log report is a combination of treatment logs aggregated and analyzed for an interval of time.

33. The medical market analysis system of claim 32, wherein the interval of time is a month and the treatment log report is displayed as a monthly report with a trailing monthly view.

34. The medical market analysis system of claim 30, wherein the displayed insight reports are further selected from the group consisting essentially of market trend reports, customized market reports based upon physician survey and combinations thereof.

35. The medical market analysis system of claim 30, further including providing a user access limited to at least two of the three modules.

36. The medical market analysis system of claim 30, further including providing supplemental information modules selected from the group consisting essentially of trial site profiling, institution clinical trial analysis, field activity tracking systems and combinations thereof.

37. The medical analysis system of claim 36, wherein the field activity tracking systems module includes field uploaded data supplements providing prefilled intelligence forms with validated customer relationship management resources.

38. The medical market analysis system of claim 30, further including providing a professional profile of the thought leader physician including publications and clinical trials related to the thought leader physician and providing a profile of an institution.

39. The medical market analysis system of claim 30, further including updating in real-time the provided publications and clinical trials wherein available hyper links to each clinical trial and publication are provided.

40. The medical market analysis system of claim 30, wherein the graphically represented thought leader's influence includes graphically representing the thought leader's influence to one or more additional thought leaders, wherein the additional thought leaders select the thought leader physician.
